(19) United States
(12) Patent Application Publication
(10) Pub. No.: US 2024/0244399 A1
(43) Pub. Date: Jul. 18, 2024

(54) METHOD FOR SUPPORTING TERMINAL GROUP BASED SERVICES AND DEVICES PERFORMING THE SAME

(71) Applicant: ELECTRONICS AND TELECOMMUNICATIONS RESEARCH INSTITUTE, Daejeon (KR)

(72) Inventors: JIHOON SUNG, Daejeon (KR); Myung Ki SHIN, Seoul (KR)

(21) Appl. No.: 18/232,434

(22) Filed: Aug. 10, 2023

(30) Foreign Application Priority Data
Aug. 10, 2022 (KR) 10-2022-0100130
Apr. 7, 2023 (KR) 10-2023-0046279
Apr. 25, 2023 (KR) 10-2023-0054142
May 12, 2023 (KR) 10-2023-0061774
May 31, 2023 (KR) 10-2023-0069990
Jul. 21, 2023 (KR) 10-2023-0095500
Jul. 31, 2023 (KR) 10-2023-0099963
Aug. 2, 2023 (KR) 10-2023-0100990
Aug. 9, 2023 (KR) 10-2023-0104147

(51) Int. Cl. H04W 4/06; H04W 28/02; H04W 76/40

(52) U.S. Cl. CPC H04W 4/06; H04W 28/0268; H04W 76/40

(57) ABSTRACT

Disclosed are a method of supporting terminal group-based services and devices for performing the same. The method of supporting terminal group-based services according to an embodiment may include receiving a multi-member application function (AF) session request with required quality of service (QoS) for a list of user equipments (UEs), converting the multi-member AF session request into an AF session request with required QoS for a serving policy control function (PCF) of each UE, and interacting with the serving PCF of each UE for each AF session, wherein the list of UEs may be identified by UE Internet Protocol (IP) addresses.

### TECHNICAL FIELD

The following disclosure relates to a method of supporting terminal group-based services and devices for performing the same.

### BACKGROUND ART

Redundant transmission for high-reliability communication for ultra-reliable low latency communications (URLLC) and quality of service (QoS) monitoring for URLLC are used for general artificial intelligence (AI)/machine learning (ML) operations, including a federated learning (FL) operation, to achieve reliable AI/ML operations and perform QoS monitoring for services.

In particular, in a case where multiple user equipments (UEs) (e.g., a group of UEs) participate in AI/ML operations as training devices, as in FL or split learning, group-based operation should be supported for efficient operation. In fifth generation (5G) systems, 5G virtual network (VN) group communication may be a solution for group-based operation, but the solution has a fatal limitation in not supporting dynamic situations flexibly because it relies on static or quasi-static group identification, which is typically managed by unified data management (UDM).

The above description is information the inventor(s) acquired during the course of conceiving the present disclosure, or already possessed at the time, and is not necessarily art publicly known before the present application was filed.

### SUMMARY

### Technical Solutions

According to an embodiment, a method of supporting terminal group-based services includes receiving a multi-member application function (AF) session request with required quality of service (QoS) for a list of user equipments (UEs), converting the multi-member AF session request into an AF session request with required QoS for a serving policy control function (PCF) of each UE, and interacting with the serving PCF of each UE for each AF session, wherein the list of UEs may be identified by UE Internet Protocol (IP) addresses.

The multi-member AF session request may include one or more of a Nnef_AFSessionWithQoS_Create request, a Nnef_AFSessionWithQoS_Notify request, a Nnef_AFSessionWithQoS_Revoke request, and a Nnef_AFSessionWithQoS_Update request.

The method may further include subscribing to QoS monitoring for each AF session for each UE.

The multi-member AF session request may include a consolidated data rate threshold.

The method may further include aggregating a data rate in a set of QoS flows selected for the consolidated data rate threshold.

The method may further include transmitting a QoS monitoring report if the aggregated data rate exceeds the consolidated data rate threshold.

The method may further include transmitting a QoS monitoring report according to a reporting frequency if the aggregated data rate does not exceed the consolidated data rate threshold.

A QoS parameter to be measured, included in the multi-member AF session request, may indicate a guaranteed bitrate for the AF session.

According to an embodiment, an apparatus for supporting terminal group-based services includes a processor, and a memory electrically connected to the processor and configured to store instructions executable by the processor, wherein when the instructions are executed by the processor, the instructions may cause the processor to perform a plurality of operations, wherein the plurality of operations may include receiving a multi-member AF session request with required QoS for a list of UEs, converting the multi-member AF session request into an AF session request with required QoS for a serving PCF of each UE, and interacting with the serving PCF of each UE for each AF session, wherein the list of UEs may be identified by UE Internet Protocol (IP) addresses.

The multi-member AF session request may include one or more of a Nnef_AFSessionWithQoS_Create request, a Nnef_AFSessionWithQoS_Notify request, a Nnef_AFSessionWithQoS_Revoke request, and a Nnef_AFSessionWithQoS_Update request.

The plurality of operations may further include subscribing to QoS monitoring for each AF session for each UE.

The multi-member AF session request may include a consolidated data rate threshold.

The plurality of operations may further include aggregating a data rate in a set of QoS flows selected for the consolidated data rate threshold.

The plurality of operations may further include transmitting a QoS monitoring report if the aggregated data rate exceeds the consolidated data rate threshold.

The plurality of operations may further include transmitting a QoS monitoring report according to a reporting frequency if the aggregated data rate does not exceed the consolidated data rate threshold.

A QoS parameter to be measured, included in the multi-member AF session request, may indicate a guaranteed bitrate for the AF session.

### BRIEF DESCRIPTION OF THE DRAWINGS

FIG. 1 illustrates a network system according to an embodiment.

FIG. 2 is a diagram illustrating a method of supporting terminal group-based services according to an embodiment.

FIG. 3 illustrates a procedure for creating a multi-member application function (AF) session with required quality of service (QoS) for a list of user equipments (UEs) according to an embodiment.

FIG. 4 illustrates a procedure for updating a multi-member AF session with required QoS for a list of UEs according to an embodiment.

FIG. 5 illustrates a procedure for revoking a multi-member AF session with required QoS for a list of UEs according to an embodiment.

FIG. 6 is a schematic block diagram of an apparatus for supporting terminal group-based services according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly, the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by those having ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and any repeated description related thereto will be omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third generation partnership project (3GPP) association, are used. However, embodiments described hereinafter are not limited to the terms and names and a system in compliance with other standards may be applicable in the same manner.

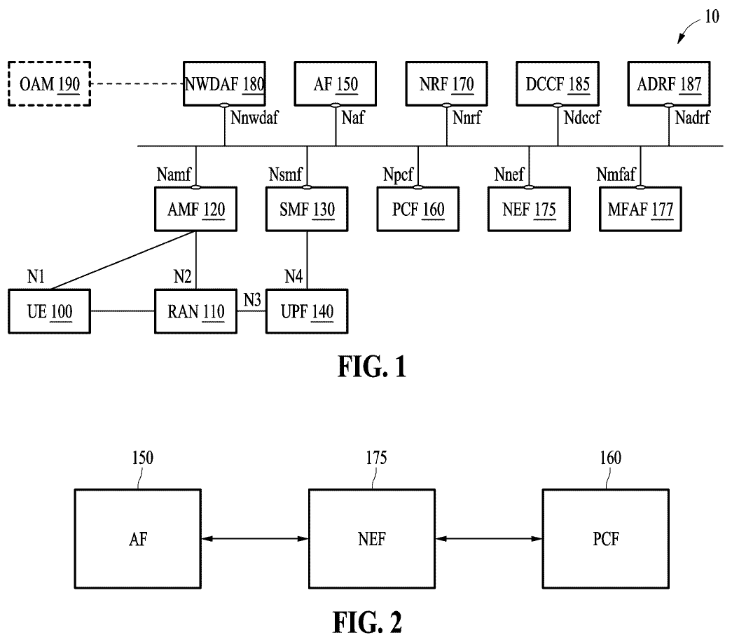

FIG. 1 illustrates a network system according to an embodiment.

Referring to FIG. 1, according to an embodiment, a network system 10 (e.g., a 5G network system) may include a plurality of entities 100 to 190. A user equipment (UE) (or a user terminal) 100 may be connected to a 5G core network via a radio access network (RAN) 110. The RAN 110 may be a base station providing a wireless communication function to the UE 100. An operation, administration, and maintenance (OAM) 190 may be a system for managing a terminal (e.g., the UE 100) and a network.

Units for performing the respective functions provided by the network system 10 may be defined as network functions (NFs). The NFs may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a messaging framework adapter function (MFAF) 177, a network data analytics function (NWDAF) 180, a data collection coordination function (DCCF) 185, and an analytics data repository function (ADRF) 187.

The AMF 120 may manage network access and mobility of a terminal (e.g., the UE 100), the SMF 130 may perform a function associated with a session, the UPF 140 may transmit user data, and the AF 150 may communicate with 5G core (5GC) to provide an application service. The PCF 160 may manage policies (e.g., a mobile communication service provider's service policy for terminals, a charging policy, and a packet data unit (PDU) session policy). The NRF 170 may store status information of the NFs and process a request to find an NF accessible by other NFs. The NWDAF 180 may provide an analytics result by analyzing data collected in a network (e.g., a 5G network) to support network automation.

The NEF 175 may subscribe to, request to change, and transmit data about information related to a terminal (e.g., the UE 100) in the network system 10. For example, the NEF 175 may subscribe to a mobility management event of a terminal (e.g., the UE 100), subscribe to a session management event of a terminal (e.g., the UE 100), request information related to a session of a terminal (e.g., the UE 100), set charging information of a terminal (e.g., the UE 100), request to change a PDU session policy for a terminal (e.g., the UE 100), and transmit small data for a terminal (e.g., the UE 100).

FIG. 2 is a diagram illustrating a method of supporting terminal group-based services according to an embodiment.

The AF 150 and the NEF 175 may support group-based operation. In a case where multiple UEs (e.g., a group of UEs) participate in artificial intelligence (AI)/machine learning (ML) operations as training devices, as in federated learning (FL) or split learning, the group-based operation may be supported for efficient operation. The group-based operation supported by the AF 150 and the NEF 175 may be supported based on an NF service (e.g., Nnef_AFSessionWithQoS) provided by the NEF 175. NF services provided by the NEF 175 may be as shown in [Table 1].

TABLE 1

| Service Name | Description |
|---|---|
| Nnef_EventExposure | Provides support for event exposure. |
| Nnef_PFDManagement | Provides support for PFDs management. |
| Nnef_ParameterProvision | Provides support to provision information which can be |
| | used for the UE in 5GS. |
| Nnef_Trigger | Provides support for device triggering. |
| Nnef_BDTPNegotiation | Provides support for background data transfer policy |
| | negotiation and optionally notification for the |
| | renegotiation. |
| Nnef_TrafficInfluence | Provide the ability to influence traffic routing. |
| Nnef_ChargeableParty | Requests to become the chargeable party for a data |
| | session for a UE. |
| Nnef_AFsessionWithQoS | Requests the network to provide a specific QoS for an |
| | AF session. |
| Nnef_MSISDN-less_MO_SMS | Used by the NEF to send MSISDN-less MO SM to the AF. |
| Nnef_ServiceParameter | Provides support to provision service specific |
| | information. |
| Nnef_APISupportCapability | Provides support for awareness on availability or |
| | expected level of a service API. |
| Nnef_NIDDConfiguration | Used for configuring necessary information for data |
| | delivery via the NIDD API. |
| Nnef_NIDD | Used for NEF anchored MO and MT unstructured data |
| | transport. |
| Nnef_SMContext | Provides the capability to create, update or release the |
| | SMF-NEF Connection. |
| Nnef_AnalyticsExposure | Provides support for exposure of network analytics. |
| Nnef_UCMFProvisioning | Provides the ability to configure the UCMF with |
| | dictionary entries consisting of UE |
| | manufacturer-assigned UE Radio Capability IDs, the |
| | corresponding UE radio capabilities, the corresponding |
| | UE Radio Capability for Paging and the (list of) |
| | associated IMEI/TAC value(s) via the NEF. The UE |
| | radio capabilities the NEF provides for a UE radio |
| | Capability ID can be in TS 36.331 [51] format, |
| | TS 38.331 [28] format or both formats. Also used for |
| | deletion (e.g. as no longer used) or update (e.g. to add or |
| | remove a (list of) IMEI/TAC value(s) associated to an |
| | entry) of dictionary entries in the UCMF. |
| Nnef_ECRestriction | Provides support for queuing status of enhanced |
| | coverage restriction, or enable/disable enhanced |
| | coverage restriction per individual UEs. |
| Nnef_ApplyPolicy | Provides the capability to apply a previously negotiated |
| | Background Data Transfer Policy to a UE or a group of UEs. |
| Nnef_Location | Provides the capability to deliver UE location to AF. |
| Nnef_AMInfluence | Provides the ability to influence access and mobility |
| | management related policies for one or multiple UEs. |
| Nnef_AMPolicyAuthorization | Provides the ability to provide inputs that can be used by |
| | the PCF for deciding access and mobility management |
| | related policies. |
| Nnef_AKMA | AKMA Application Key derivation service. |
| Nnef_Authentication | This service enables the consumer to authenticate and |
| | authorize the Service Level Device Identity as described |
| | in TS 23.256 [136]. |
| Nnef_TimeSynchronization | Provides the ability to support for (g)PTP or 5G access |
| | stratum based time synchronization service. |
| Nnef_EASDeployment | EAS deployment service. |
| Nnef_UEId | UE Identifier service, which supports to retrieve AF |
| | specific UE Identifier based on UE address. |
| Nnef_MBSTMGI | Allows AF to request allocation/deallocation of |
| | TMGI(s) for MBS Session. |
| Nnef_MBSSession | Allows AF to create, update and delete MBS Session. |
| Nnef_MBSGroupMsgDelivery | Allows AF to request to create, update and delete |
| | resource for group message delivery via MBS Session. |
| Nnef_ASTI | Provides the ability to influence 5G access stratum based |
| | time distribution configuration. |
| Nnef_SMService | Used for SBI-based MO SM transmit through NEF for |
| | MSISDN-less MO SMS. |
| Nnef_PDTQPolicyNegotiation | Provides support for negotiation for Planned Data |
| | Transfer with QoS requirements policy and optionally |
| | notification for the renegotiation. |
| Nnef_MemberUESelectionAssistance | Provides one or more list(s) of candidate UE(s) (among |
| | the list of target member UE(s) provided by the AF) and |
| | additional information based on the parameters |
| | contained in the request from the AF. |
| Nnef_DNAIMapping | Allows AF to obtain DNAI. |
| Nnef_TrafficInfluenceData | Used in HR SBO as defined in TS 23.548 [130] to get |
| | AF Traffic Influence configuration from the V-NEF. |
| Nnef_TrafficCorrelation_Notify | Used for SMF determined information related to the |
| | members of the set of UEs identified by traffic |
| | correlation ID as defined in TS 23.548 [130]. |

The terminal group-based service operation supported by the AF 150 and the NEF 175 may include a procedure for requesting a quality of service (QoS) for communication between the AF 150 and a set of UEs (e.g., UEs included in a set) and performing QoS monitoring. The set of UEs may be identified by a list of UE addresses. The terminal group-based service operation according to an embodiment may be performed according to a multi-member AF session request with required QoS (e.g., Nnef_MultiMemberAFSessionWithQoS Request) for the list of UEs identified by their IP addresses.

The AF 150 may control the terminal group-based service operation. The AF 150 may control an operation for a multi-member AF session with required QoS for the list of UEs.

The AF 150 may transmit a multi-member AF session request with required QoS for the list of UEs to the NEF 175. The list of UEs may be identified by UE Internet Protocol (IP) address(es). For example, the list of UEs may include a port number along with an IP address used by a UE (e.g., the UE 100) for communication with the AF 150, for all UEs in the list.

The NEF 175 may receive the multi-member AF session request with required QoS for the list of UEs from the AF 150. Thereafter, the NEF 175 may convert the multi-member AF session request into individual requests for AF sessions with required QoS (e.g., one request for an individual AF session with required QoS per UE address) and interact with a serving PCF (e.g., the PCF 180) of each UE on a per AF session basis (e.g., apply an AF session request with required QoS). The interaction process follows an AF session procedure with required QoS, except for TSCTSF intervention and provision of TSCTSF-related information.

The NEF 175 may receive the outcome of the individual requests for AF sessions (e.g., individual AF sessions with required QoS) corresponding to the IP address of each UE, and consolidate the received outcomes of the individual AF sessions into a single response before forwarding the same to the AF 150. For example, the NEF 175 may consolidate the outcomes of the individual AF sessions into a single response based on a configured time (e.g., set as “0”) by NEF 175.

Depending on the details of the multi-member AF session with required QoS, optimization from the NEF 175 to AF signaling may be achieved through consolidation and NEF configured time. The NEF 175 may transmit multiple responses (e.g., as RAN nodes may respond late or signaling messages may get lost), and the details of the NEF operation (e.g., related to the processing of UE addresses for which no response has been received within the NEF configured time) may be defined by Create, Update, and Revoke operations. The AF 150 may subscribe to QoS monitoring for the multi-member AF session with required QoS. QoS monitoring may be activated by the NEF 175 by interacting with each of the serving PCFs of a UE on a per AF session basis. QoS monitoring may be activated for the entire list of UEs. If an AF request (e.g., the multi-member AF session request) includes QoS monitoring information without an indication of direct event notification, the NEF 175 may include that indication in the request so that the QoS monitoring report is transmitted from the UPF directly to the NEF 175. The NEF 175 may forward the QoS monitoring reports to the AF 150 together with the respective UE address individually or, optionally, in an aggregated manner based on the NEF configured time.

When the AF 150 subscribes to QoS monitoring for the list of UEs (e.g., QoS monitoring of the UL and/or DL data rate), the AF 150 may provide a consolidated data rate threshold that is stored in the NEF 175. The NEF 175 may subscribe to QoS monitoring for each AF session (e.g., with required QoS parameter(s)) for each UE. The consolidated data rate threshold (e.g., consolidated maximum bit rate) may define an upper bound of the aggregated data rate across all traffic flows corresponding to the list of UE addresses of the multi-member AF session with required QoS. If only a part of the UEs (e.g., some UEs) participate in the current communication with the AF 150 and the NEF 175 maintains this list, the AF 150 may provide in addition a specific list of UE addresses subject to consolidated data rate monitoring (e.g., which is a subset of the general list of UE addresses). The NEF 175 may aggregate the UE's QoS monitoring reports for data rate for the UE addresses that appear in the specific list of UE addresses subject to consolidated data rate monitoring, and otherwise, for all UE addresses that appear in the general list of UE addresses maintained in the NEF 175 for the multi-member AF session with required QoS. Only if the aggregated data rate exceeds the consolidated data rate threshold, the QoS monitoring report of each UE for data rate may be transmitted to the AF 150 by the NEF 175.

Table 2 may show the mapping of four types of NEF service requests for the multi-member AF session with required QoS to N5 service requests. Table 3 describes the corresponding NEF service requests to the PCF 180 using an Npcf_PolicyAuthorization service. The multi-member AF session may be expressed as an Nnef_AFSessionWithQoS Request or an Nnef_MultiMemberAFSessionWithQoS Request.

TABLE 2

| Nnef_AFSessionWithQoS Request | N5 request |
|---|---|
| Create | Requesting to allocate network resources to support |
| | a list of UEs' communication with the AF and the |
| | UEs are identified by the UE IP address(es). In |
| | addition, the AF can subscribe to be notified of QoS |
| | Monitoring reports. |
| Update | Updating (a) the list of UEs, (b) the requested QoS |
| | (c) the type of QoS monitoring for the list of QoS |
| | flows. |
| | More than one of the above operations can be |
| | requested at the same time. |
| Revoke | Deleting the establishment of the Multi-member AF |
| | session for a list of UEs. |
| Notify | Notifying AF with the individual or aggregated |
| | QoS monitoring report for a specific list of AF |
| | sessions |

TABLE 3

| Nnef_AFSessionWithQoS Request | Npcf_PolicyAuthorization request |
|---|---|
| Create | Npcf_PolicyAuthorization Create request for each |
| | UE address received in the |
| | Nnef_AFSessionWithQoS Request. |
| | Npcf_PolicyAuthorization Subscribe to request |
| | QoS Monitoring for each QoS Monitoring request |
| | received in the Nnef_AFSessionWithQoS Request. |
| Update | Npcf_PolicyAuthorization Update request to update |
| | the QoS and/or QoS monitoring which may include |
| | the Consolidated Data Rate monitoring received in |
| | the Nnef_AFSessionWithQoS_Update Request. |
| | Npcf_PolicyAuthorization Create request for each |
| | added UE address received in the |
| | Nnef_AFSessionWithQoS Request. |
| | Npcf_PolicyAuthorization Delete request for each |
| | removed UE address received in the |
| | Nnef_AFSessionWithQoS Request. |
| | Npcf_PolicyAuthorization Subscribe |
| | QoS Monitoring for each new QoS Monitoring |
| | request received in the Nnef_AFSessionWithQoS |
| | Request. |
| | More than one of the above operations can be |
| | requested at the same time. |
| Revoke | Npcf_PolicyAuthorization Delete request for each |
| | UE address received in the |
| | Nnef_AFSessionWithQoS Request. |
| Notify | Npcf_PolicyAuthorization Notify to report the |
| | events that NEF subscribed to. |

The Nnef_AFSessionWithQoS service may be used to support the resource allocation to provide specific QoS for a list of UEs and to support subscription and notification of QoS monitoring event for data rate monitoring for a list of QoS flows. The Nnef_AFSessionWithQoS service may include an Nnef_AFSessionWithQoS_Create service operation, an Nnef_AFSessionWithQoS_Notify service operation, an Nnef_AFSessionWithQoS_Revoke service operation, and an Nnef_AFSessionWithQoS_Update service operation.

### Nnef_AFSessionWithQoS_Create Service Operation

This service operation may allow a consumer NF (e.g., the AF 150) to request a network to allocate resources for a specific list of AF sessions and potentially to perform QoS monitoring (e.g., delay, jitter, bit rate, or consolidated data rate).

Inputs, Required: AF identifier, a list of UE addresses (e.g., IP addresses), flow description information, external application identifier, QoS reference, or individual QoS parameters

Inputs, Optional: Time period, traffic volume, alternative service requirements (e.g., containing one or more QoS reference parameters or requested alternative QoS parameter sets in a prioritized order), QoS parameter(s) to be measured, consolidated data rate threshold, a list of UE addresses subject to consolidated data rate threshold, reporting frequency, target of reporting, and an indication of local event notification, DNN (e.g., if available), S-NSSAI (e.g., if available), flow direction

If the consolidated data rate threshold is provided, the QoS parameter(s) to be measured may indicate the guaranteed bitrate for the requested AF sessions.

If the multi-member AF request is for consolidated data rate monitoring, the QoS flow data rate reporting for the group of UEs may be provided to the AF 150 by the NEF 175 only when the consolidated data rate threshold is exceeded.

When the consolidated data rate threshold is provided, this may apply to the list of UE addresses by default. However, if the list of UE addresses subject to consolidated data rate monitoring is also provided, then the list should be a subset of the list of UE addresses.

Outputs, Required: Transaction reference ID, result for the success or failure of the request(s) corresponding to individual UE(s) in the list.

Outputs, Optional: None.

### Nnef_AFSessionWithQoS_Notify Service Operation

The NEF 175 may report the QoS flow level event(s) to the consumer NF (e.g., the AF 150) through this service operation.

Inputs, Required: Transaction reference ID, reports of the events

If the event report is for consolidated data rate monitoring, the QoS flow data rate reporting for the list of UEs may be provided to the AF by the NEF only when the consolidated data rate threshold is exceeded.

Inputs, Optional: When the event report is for consolidated data rate monitoring, the Nnef_AFSessionWithQoS_Notify service may include a consolidated data rate monitoring report.

Outputs, Required: None.

Outputs, Optional: None.

### Nnef_AFSessionWithQoS_Revoke Service Operation

The consumer NF (e.g., the AF 150) may request the network to revoke the list of AF sessions with required QoS.

Inputs, Required: Transaction reference ID.

Inputs, Optional: None.

Outputs, Required: Transaction reference ID, result for the success or failure of the request corresponding to individual UE.

Outputs, Optional: None.

### Nnef_AFSessionWithQoS_Update Service Operation

The consumer NF (e.g., the AF 150) may request the network to update the list of UEs (e.g., identified by IP addresses) for the list of AF sessions, the service requirement(s) and/or additional alternative service requirement(s) for the list of AF sessions, and/or the type of QoS monitoring through this service operation.

Inputs, Required: Transaction reference ID, a list of UE addresses (e.g., IP addresses).

Inputs, Optional: Flow description information, QoS reference or individual QoS parameters, time period, traffic volume, alternative service requirements (e.g., containing one or more QoS reference parameters or requested alternative QoS parameter sets in a prioritized order), QoS parameter(s) to be measured, consolidated data rate threshold, a list of UE addresses subject to consolidate data rate monitoring, reporting frequency, target of reporting, and an indication of local event notification, flow direction.

If the consolidated data rate threshold is provided, the QoS parameter(s) to be measured may indicate the guaranteed bitrate for the requested AF sessions.

If the AF request (e.g., the multi-member AF request) is for consolidated data rate monitoring, the QoS flow data rate reporting for the group of UEs may be provided to the AF 150 by the NEF 175 only when the group data rate threshold (e.g., consolidated data rate threshold) is exceeded.

When the consolidated data rate threshold is provided, this may apply to the list of UE addresses by default. However, if the list of UE addresses subject to consolidated data rate monitoring is also provided, then the list should be a subset of the list of UE addresses.

If the AF 150 wants to terminate the consolidated data rate monitoring, the AF 150 may not include the consolidated data rate threshold in the AF request.

What is to be updated may be determined based on the combination of inputs. If the AF request includes a new UE in the required inputs, the new UE may be considered to be a new UE to the list of UE(s). If the AF request includes an existing UE in the required inputs without optional inputs, the existing UE may be considered to be removed from the list of UE(s). If the AF request includes an existing UE in the required inputs with optional inputs for the resource allocation or QoS monitoring type, the resource allocation or QoS monitoring type of the existing UE may be considered to be updated.

Outputs, Required: Transaction reference ID, result for the success or failure of the operation execution result.

Outputs, Optional: None.

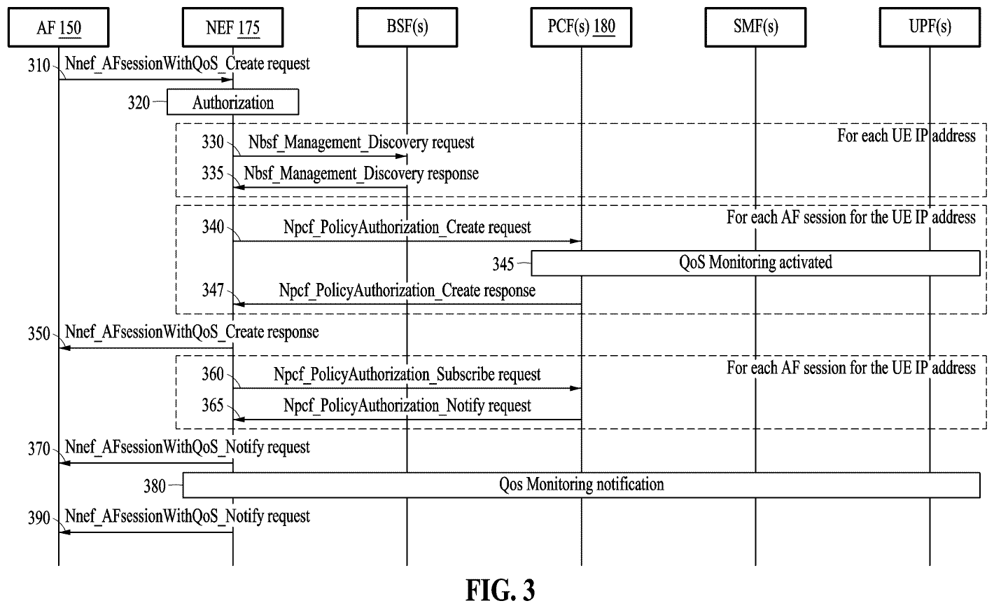

FIG. 3 illustrates a procedure for creating a multi-member AF session with required QoS for a list of UEs according to an embodiment.

In operation 310, the AF 150 may transmit a request to reserve resources for traffic flows for the communication between a set of UEs and the AF 150 to the NEF 175 using an Nnef_AFsessionWithQoS_Create request message. The Nnef_AFsessionWithQoS_Create request message may include a list of UE addresses, AF identifier, flow description information or external application identifier, QoS reference or individual QoS parameter(s), alternative service requirements, QoS parameter(s) to be measured, reporting frequency, target of reporting, an optional indication of local event notification, consolidated data rate threshold, DNN, and S-NSSAI. The AF 150 may provide one or more of the following individual QoS parameters, instead of the QoS reference. The individual QoS parameters may include requested 5GS delay (e.g., optional), requested priority (e.g., optional), requested guaranteed bitrate, requested maximum bitrate, maximum burst size, and requested packet error rate. The optional alternative service requirements provided by the AF 150 may include QoS reference or requested alternative QoS parameter set(s) in a prioritized order. The AF 150 may provide QoS parameter(s) to be measured, reporting frequency, target of reporting, and an optional indication of local event notification.

The AF 150 may also provide the consolidated data rate threshold and optionally, the list of UE addresses subject to consolidated data rate monitoring. In this case, the AF 150 may subscribe to QoS monitoring to monitor the UL and/or DL data rate.

When the consolidated data rate threshold is provided, that may apply to the list of UE addresses of the multi-member AF session with required QoS by default. If the list of UE addresses subject to consolidated data rate monitoring is provided together with the consolidated data rate threshold, then the list may be a subset of the list of UE addresses.

In operation 320, the NEF 175 may authorize the AF request (e.g., the Nnef_AFsessionWithQoS_Create request) and apply policies to control the overall amount of QoS authorized for the AF 150. If the authorization is not granted, all operations (except operation 350) may be skipped, and the NEF 175 may reply to the AF 150 with a result value indicating that the authorization failed. The NEF 175 may generate the transaction reference ID and associate the list of UE addresses received from the AF 150 to the transaction reference ID. Only when both the consolidated data rate threshold and a QoS monitoring request for data rate are provided by the AF 150, the NEF 175 may perform consolidated data rate monitoring.

If the NEF 175 recognizes, based on configuration, that the IP address(es) received in the list of UE addresses are different from the IP address(es) assigned by 5GC (e.g., when the UE(s) are behind a NAT in UPFs), the NEF 175 may perform an AF specific UE ID retrieval procedure for each UE IP address with port number, in order to identify the corresponding IP address (and IP domain, if necessary) that has been assigned by the 5GC. The NEF 175 may then use the respective corresponding IP address (and IP domain, if necessary) in the following operations instead of the UE IP address provided by the AF 150.

In operations 330 and 335, the NEF 175 may find a BSF serving the UE IP address(es) using an NRF and then for each UE IP address, use an Nbsf_Management_Discovery service operation, providing the UE IP address, to discover each PCF 180 (e.g., the responsible PCF) for the PDU session.

Operations 340 to 365 may apply to each UE address in the list of UE addresses.

In operation 340, the NEF 175 may provide the UE address and the received parameters in operation 310 to the PCF 180 in an Npcf_PolicyAuthorization_Create request. If the request (e.g., the Nnef_AFsessionWithQoS_Create request) contains QoS monitoring information without an indication of direct event notification, the NEF 175 may include that indication in the request (e.g., the Npcf_PolicyAuthorization_Create request) to ensure that QoS monitoring reports may be transmitted by the UPF directly to the NEF 175.

In operation 345, the PCF 180 may generate an authorized QoS monitoring policy according to the information received from the NEF 175 in operation 340 and provide PCC rules with the policy to an SMF. The SMF may configure the UPF to perform QoS monitoring.

In operation 347, the PCF 180 may transmit a Npcf_PolicyAuthorization_Create response message to the NEF 175.

In operation 350, when the NEF 175 receives the Npcf_PolicyAuthorization_Create response, the NEF 175 may transmit an Nnef_AFsessionWithQoS_Create response message (e.g., containing transaction reference ID and result for the list of UE addresses) to the AF 150. The NEF 175 may aggregate the authorization responses from the PCFs 180 and transmit the Nnef_AFsessionWithQoS_Create response message (e.g., Transaction reference ID, Result for list of UE addresses) with the aggregated authorization responses to the AF 150. The Nnef_AFsessionWithQoS_Create response message may include the aggregated authorization responses. The result for the list of UE addresses may include whether the request is successful or has failed for every UE address in the list. The NEF 175 may store the list of UE addresses for which the authorization is successful together with the QoS and the QoS monitoring information.

Operations 360 and 365 may apply to each UE address in the list of UE addresses.

In operation 370, the NEF 175 may aggregate the notifications from the PCFs 180 and transmit an Nnef_AFsessionWithQoS_Notify message (e.g., Transaction reference ID, Result for list of UE addresses) with the aggregated resource allocation status events to the AF 150. The Nnef_AFsessionWithQoS_Notify message may include the aggregated resource allocation status events. The result for the list of UE addresses may include, for every UE address in the list, the information regarding whether resources are allocated (e.g., whether resources are allocated or not allocated) or information about the allocation of resources while the currently fulfilled QoS matches an alternative service requirement. The NEF 175 may update the locally stored list of UE addresses by removing any UEs for which resources could not be allocated.

In operation 380, the QoS monitoring events may be reported to the NEF 175 based on the parameters received in operation 340. The QoS monitoring events may be reported to the NEF 175 by the UPF(s) using an Nupf_EventExposure service.

In operation 390, when the NEF 175 receives the QoS monitoring events, the NEF 175 may transmit an Nnef_AFsessionWithQoS_Notify message with the QoS monitoring events (e.g., the individual or aggregated QoS monitoring events) to the AF 150. The Nnef_AFsessionWithQoS_Notify message may include the individual or aggregated QoS monitoring events.

The AF 150 may transmit an Nnef_AFsessionWithQoS_Revoke request containing the transaction reference ID to the NEF 175 in order to revoke all AF sessions (e.g., multi-member AF sessions with required QoS) related to the transaction reference ID. The NEF 175 may authorize the revoke request and trigger Npcf_PolicyAuthorization_Delete and Npcf_PolicyAuthorization_Unsubscribe operations for every UE in the list of UE address(es) associated with the transaction reference ID.

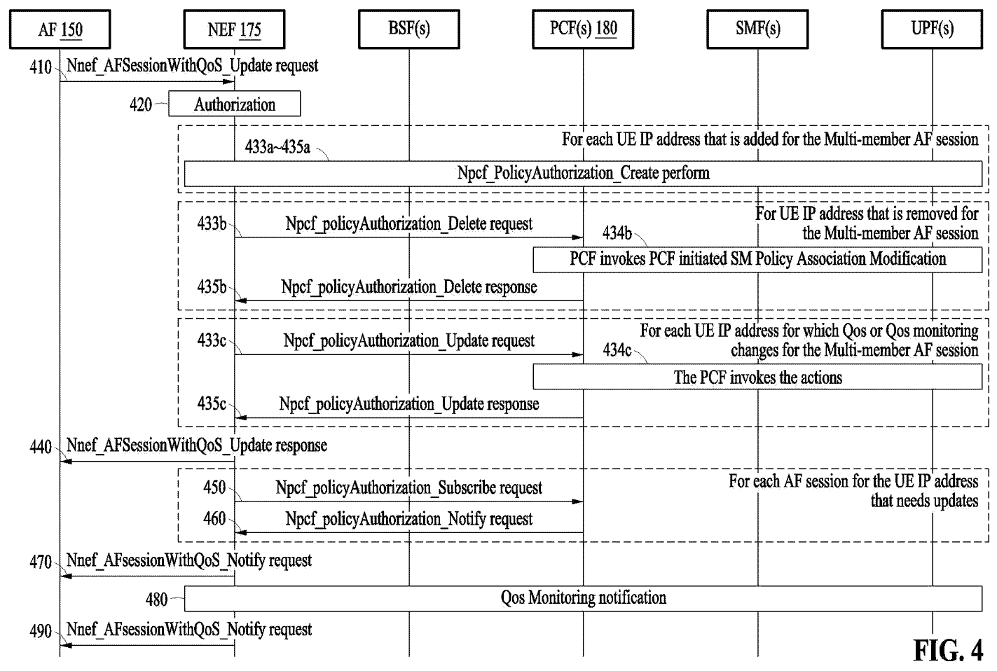

FIG. 4 illustrates a procedure for updating a multi-member AF session with required QoS for a list of UEs according to an embodiment.

In operation 410, the AF 150 may invoke an Nnef_AFSessionWithQoS_Update request through the support of the NEF 175 to start resource allocation update and/or to instruct required QoS monitoring for the list of UEs (e.g., a selected list) to support a specific application (e.g., an FL operation).

When the AF 150 requests to update the UE(s) in the list and/or to update the QoS and/or to update the QoS monitoring and/or to update consolidated data rate monitoring, the AF 150 may initiate the Nnef_AFSessionWithQoS_Update request which includes the list of UE addresses, AF identifier, transaction reference ID, [flow description information], [QoS reference or individual QoS parameters], and [alternative service requirements]. The AF 150 may transmit the Nnef_AFSessionWithQoS_Update request to the NEF 175 to update the reserved resources or update the type of QoS monitoring. The transaction reference ID provided in the AF session with required QoS update request message may be set to the transaction reference ID assigned by the NEF 175. The AF 150 may provide, instead of the QoS reference, one or more of the following individual QoS parameters: requested 5GS delay (e.g., optional), requested priority (e.g., optional), requested guaranteed bitrate, requested maximum bitrate, maximum burst size, and requested packet error rate. The Nnef_AFSessionWithQoS_Update request may further include a consolidated data rate threshold for consolidated data rate monitoring. The list of UE addresses subject to consolidated data rate monitoring may be provided. The optional alternative service requirements provided by the AF 150 may include QoS reference or requested alternative QoS parameter set(s) in a prioritized order.

For example, if QoS monitoring or consolidated data rate monitoring has not been done during the procedure for creating a multi-member AF session with required QoS of FIG. 3, the AF 150 may subscribe to QoS monitoring or consolidated data rate monitoring for the multi-member AF session with required QoS.

If the AF 150 wants to terminate the consolidated data rate monitoring for the multi-member AF session, the AF 150 may not include the consolidated data rate threshold in the AF request (e.g., the Nnef_AFSessionWithQoS_Update request).

In operation 420, the NEF 175 may authorize the multi-member AF request (e.g., the Nnef_AFSessionWithQoS_Update request) and apply policies to control the overall amount of QoS authorized for the AF 150. If the authorization is not granted, all following operations may be skipped, and the NEF 175 may reply to the AF 150 with a result value indicating that the authorization failed.

In operation 433 (e.g., operation 433a, operation 433b, and operation 433c) to operation 435 (e.g., operation 435a, operation 435b, and operation 435c), when the AF 150 provides the Nnef_AFSessionWithQoS_Update request in order to add/update/remove the consolidated data rate threshold or the list of UE addresses subject to consolidated data rate monitoring, the NEF 175 may update its local context and may not interact with the PCF 180 (e.g., unless required for reasons described in the following).

When the AF 150 provides the Nnef_AFSessionWithQoS_Update request in order to update the list of UE addresses, to update the QoS, and/or to update the QoS monitoring, the NEF 175 may refer to the locally stored information (e.g., the list of UE addresses and the QoS and QoS monitoring information), and determine new UE address to be added to the list, and/or the existing UE address to be removed from the list, and/or the existing UE address(es) for which the QoS or the QoS monitoring (or both) is to be updated. Then, the NEF 175 may continue by invoking one of the following Npcf_PolicyAuthorization procedures for every affected UE address.

If the multi-member AF session update request (e.g., Nnef_AFSessionWithQoS_Update) involves a new UE is to be added to the list, the Npcf_PolicyAuthorization procedure according to operation 433a, operation 434a, and operation 435a may be performed. After inquiring BSF via an Nbsf_Management Discovery service operation to find out the address of the serving PC 180 of the corresponding UE, the NEF 175 may initiate Npcf_PolicyAuthorization_Create excluding TSCTSF-related procedures toward the PCF 180 of the corresponding UE. The NEF 175 may use the latest information on QoS and QoS monitoring for the interaction with the PCF 180. If the authorization is successful, the NEF 175 may add the address of the new UE to the locally stored list of UE addresses.

If the multi-member AF session update request (e.g., Nnef_AFSessionWithQoS_Update) involves an existing UE is to be removed from the list, the Npcf_PolicyAuthorization procedure according to operation 433b, operation 434b, and operation 435b may be performed. The NEF 175 may initiate Npcf_PolicyAuthorization_Delete excluding TSCTSF-related info toward the PCF 180 for the corresponding UE. The NEF 175 may remove the corresponding UE address from the locally stored list of UE addresses.

If the multi-member AF session update request (e.g., Nnef_AFSessionWithQoS_Update) involves either the update of QoS or QoS monitoring or both (e.g., QoS update and QoS monitoring) for an existing UE in the group, the Npcf_PolicyAuthorization procedure according to operation 433c, operation 434c, and operation 435c may be performed. The NEF 175 may initiate Npcf_PolicyAuthorization_Update to the serving PCF(s) of the corresponding UE. The NEF 175 may remove any UE address(es) for which the authorization of the update request has failed from the list of UE addresses. The NEF 175 may store any change (or any changed matter) to the QoS or the QoS monitoring information.

In operation 440, if an interaction with the PCF 180 occurs during operation 435 (e.g., operation 435a, operation 435b, and operation 435c), the NEF 175 may aggregate the authorization responses from the PCF(s) 180 and transmit an Nnef_AFSessionWithQoS update response (e.g., Transaction reference ID, Result for list of UE addresses) along with the aggregated authorization results to the AF 150. The Nnef_AFSessionWithQoS update response may include the aggregated authorization results. The result for the list of UE addresses may include whether the request is granted for every UE address in the list.

If no interaction with PCF(s) has occurred during operation 434 (e.g., operation 34a, operation 434b, and operation 434c) and operation 435 (e.g., operation 435a, operation 435b, and operation 435c), the NEF 175 may transmit an Nnef_AFSessionWithQoS Update response (e.g., Transaction reference ID, Result) with the result of the consolidated data rate monitoring-related change (or changed matter) to the AF 150. The Nnef_AFSessionWithQoS update response may include the result of the consolidated data rate monitoring-related change (or changed matter).

In operation 450, for every UE address that has been added to the locally stored list of UE addresses, the NEF 175 may transmit an Npcf_PolicyAuthorization_Subscribe message to the corresponding PCF(s) 180 to subscribe to notifications of resource allocation status and may subscribe to other events. If an update of event subscription is requested by the AF 150, the NEF 175 may update the event subscription with the corresponding PCF(s) 180 for every UE address in the locally stored list of UE addresses.

Operation 460 may apply at least for the UE addresses for which the establishment or update of transmission resources is requested by the PCF(s) 180.

In operation 470, when the establishment or update of transmission resources occurs, the NEF 175 may receive Npcf_PolicyAuthorization Notify messages from the serving PCF(s) 180 of the UE about the resource allocation status. The NEF 175 may aggregate the notifications from the serving PCFs 180 of each UE before notifying the AF 150 with an Nnef_AFSessionWithQoS_Notify message (e.g., Transaction reference ID, Result for list of UE addresses). The result for the list of UE addresses may include, for every UE address in the list, the information regarding whether resources are allocated (e.g., whether resources are allocated or not allocated) or information about the allocation of resources while the currently fulfilled QoS matches an alternative service requirement. The NEF 175 may update the locally stored list of UE addresses by removing any UEs for which resources could not be allocated.

For the UE address(es) that did not get any resources, the AF 150 may request resource reservation again, by adding the corresponding address(es) to the list of UE address(es) as described in FIG. 3.

In operation 480, if a direct event notification is requested, the UPF(s) may provide QoS monitoring events to the NEF 175 using an Nupf_EventExposure service.

In operation 490, when the NEF 175 receives the QoS monitoring events, the NEF 175 may transmit an Nnef_AFsessionWithQoS_Notify message with the individual or aggregated QoS monitoring events to the AF 150. The Nnef_AFsessionWithQoS_Notify message may include the individual or aggregated QoS monitoring events.

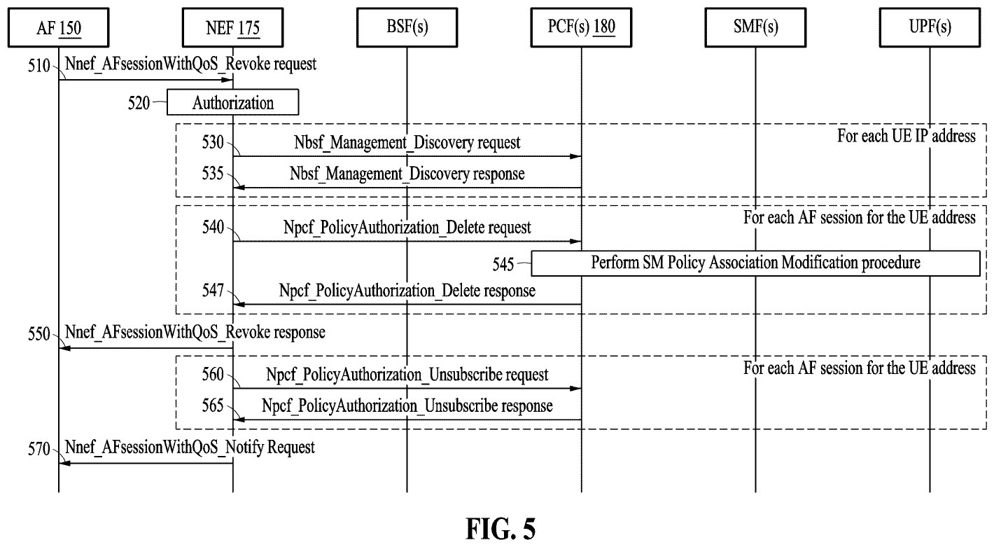

FIG. 5 illustrates a procedure for revoking a multi-member AF session with required QoS for a list of UEs according to an embodiment.

In operation 510, the AF 150 may transmit a request to revoke the allocated resources for traffic flows for the communication between a set of UEs and the AF, using an Nnef_AFsessionWithQoS_Revoke request message (e.g., containing transaction reference ID).

In operation 520, if the authorization is not granted, all operations except operation 550 may be skipped, and the NEF 175 may reply to the AF 150 with a result value indicating that the authorization failed.

In operations 530 and 535, the NEF 175 may refer to the list of UE addresses associated with the transaction reference ID and find a BSF serving the UE address(es) using an NRF. For each UE address, the NEF 175 may use an Nbsf_Management_Discovery service operation, providing the UE address, to discover the responsible PCF 180 for each of the PDU sessions.

Operations 540 to 547 may apply to each UE address in the list of UE addresses.

In operation 540, the NEF 175 may provide the UE address and the received parameters in operation 510 to the PCF 180 in an Npcf_PolicyAuthorization_Delete request excluding TSCTSF-related information for the corresponding UE.

In operation 545, the PCF 180 may request an SMF to proceed an SM Policy Association Modification procedure.

In operation 547, the PCF 180 may transmit an Npcf_PolicyAuthorization_Delete response message to the NEF 175.

In operation 550, the NEF 175 may aggregate authorization responses from the PCFs 180 and transmit an Nnef_AFsessionWithQoS_Revoke response message (e.g., containing transaction reference ID) with the aggregated authorization responses to the AF 150. The Nnef_AFsessionWithQoS_Revoke response message may include the aggregated authorization responses. The result for the list of UE addresses may include whether the authorization is successful or has failed for every UE address in the list. The NEF 175 may store the list of UE addresses for which the authorization is successful.

Operations 560 and 565 may apply to each UE address in the list of UE addresses.

In operations 560 and 565, the NEF 175 may initiate Npcf_PolicyAuthorization_Unsubscribe operations towards the respective PCF(s) 180 for every UE in the list of UE address(es) associated with the transaction reference ID, and the PCF(s) 180 may confirm the unsubscription.

In operation 570, the NEF 175 may transmit an Nnef_AFsessionWithQoS_Notify message with the event reported by the PCF 180 to the AF 150 to confirm the revocation of the multi-member AF session. The Nnef_AFsessionWithQoS_Notify message may include the event reported by the PCF 180.

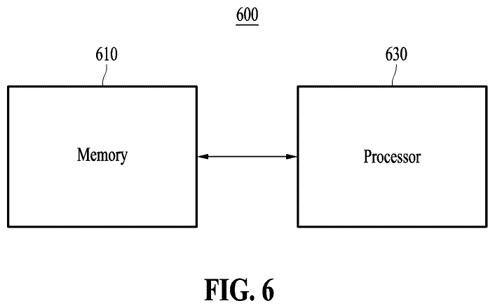

FIG. 6 is a schematic block diagram of an apparatus for supporting terminal group-based services according to an embodiment.

Referring to FIG. 6, according to an embodiment, an apparatus 600 (e.g., a server device) for supporting group-based operations may be substantially the same as the AF 150 and/or the NEF 175 described with reference to FIGS. 1 to 5. The apparatus 600 may include a memory 610 and a processor 630.

The memory 610 may store instructions (or programs) executable by the processor 630. For example, the instructions may include instructions for performing an operation of the processor 630 and/or an operation of each component of the processor 630.

The memory 610 may be implemented as a volatile or non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate Memory (NFGM), holographic memory, a molecular electronic memory device, and/or insulator resistance change memory.

The processor 630 may execute computer-readable code (e.g., software) stored in the memory 610 and instructions triggered by the processor 630. The processor 630 may be a data processing device implemented by hardware including a circuit having a physical structure to perform desired operations. The desired operations may include code or instructions included in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

An operation performed by the processor 630 may be substantially the same as the operation of the AF 150 and/or the NEF 175 described with reference to FIGS. 1 to 5. Accordingly, a further description thereof is not repeated herein.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of supporting terminal group-based services, the method comprising:
receiving a multi-member application function (AF) session request with required quality of service (QoS) for a list of user equipments (UEs);
converting the multi-member AF session request into an AF session request with required QoS for a serving policy control function (PCF) of each UE; and
interacting with the serving PCF of each UE for each AF session,
wherein the list of UEs is identified by UE Internet Protocol (IP) addresses.

2. The method of claim 1, wherein the multi-member AF session request comprises one or more of a Nnef_AFSessionWithQoS_Create request, a Nnef_AFSessionWithQoS_Notify request, a Nnef_AFSessionWithQoS_Revoke request, and a Nnef_AFSessionWithQoS_Update request.

3. The method of claim 1, further comprising:
subscribing to QoS monitoring for each AF session for each UE.

4. The method of claim 3, wherein the multi-member AF session request comprises a consolidated data rate threshold.

5. The method of claim 4, further comprising:
aggregating a data rate in a set of QoS flows selected for the consolidated data rate threshold.

6. The method of claim 5, further comprising:
transmitting a QoS monitoring report if the aggregated data rate exceeds the consolidated data rate threshold.

7. The method of claim 5, further comprising:
transmitting a QoS monitoring report according to a reporting frequency if the aggregated data rate does not exceed the consolidated data rate threshold.

8. The method of claim 4, wherein a QoS parameter to be measured, included in the multi-member AF session request, indicates a guaranteed bitrate for the AF session.

9. An apparatus for supporting terminal group-based services, the apparatus comprising:
a processor; and
a memory electrically connected to the processor and configured to store instructions executable by the processor,
wherein when the instructions are executed by the processor, the instructions cause the processor to perform a plurality of operations,
wherein the plurality of operations comprise:
receiving a multi-member application function (AF) session request with required quality of service (QoS) for a list of user equipments (UEs);
converting the multi-member AF session request into an AF session request with required QoS for a serving policy control function (PCF) of each UE; and
interacting with the serving PCF of each UE for each AF session,
wherein the list of UEs is identified by UE Internet Protocol (IP) addresses.

10. The apparatus of claim 9, wherein the multi-member AF session request comprises one or more of a Nnef_AFSessionWithQoS_Create request, a Nnef_AFSessionWithQoS_Notify request, a Nnef_AFSessionWithQoS_Revoke request, and a Nnef_AFSessionWithQoS_Update request.

11. The apparatus of claim 9, wherein the plurality of operations further comprise subscribing to QoS monitoring for each AF session for each UE.

12. The apparatus of claim 11, wherein the multi-member AF session request comprises a consolidated data rate threshold.

13. The apparatus of claim 12, wherein the plurality of operations further comprise aggregating a data rate in a set of QoS flows selected for the consolidated data rate threshold.

14. The apparatus of claim 13, wherein the plurality of operations further comprise transmitting a QoS monitoring report if the aggregated data rate exceeds the consolidated data rate threshold.

15. The apparatus of claim 13, wherein the plurality of operations further comprise transmitting a QoS monitoring report according to a reporting frequency if the aggregated data rate does not exceed the consolidated data rate threshold.

16. The apparatus of claim 12, wherein a QoS parameter to be measured, included in the multi-member AF session request, indicates a guaranteed bitrate for the AF session.
